(19) United States
(12) Patent Application Publication
(10) Pub. No.: US 2018/0040394 A1
(43) Pub. Date: Feb. 8, 2018

(54) WIRING BAR SUPPORT DEVICE, WIRE HARNESS ASSEMBLY DEVICE, AND METHOD OF MANUFACTURING WIRE HARNESS

(71) Applicant: SUMITOMO WIRING SYSTEMS, LTD., Mie (JP)

(72) Inventors: Toshio SHIMIZU, Mie (JP); Makoto NAKAHARA, Mie (JP)

(73) Assignee: SUMITOMO WIRING SYSTEMS, LTD., Mie (JP)

(21) Appl. No.: 15/664,371

(22) Filed: Jul. 31, 2017

(30) Foreign Application Priority Data
Aug. 8, 2016 (JP) 2016-155501

(51) Int. Cl. H01B 13/012

(52) U.S. Cl. CPC H01B 13/01209

(57) ABSTRACT

A wiring bar support device includes a wiring bar capable of holding an end portion of a temporary coupling or an end portion of a wire; a bar support supporting the wiring bar; and an interference inhibiting mechanism that includes an interference inhibiting member (for example, a sheet) capable of being drawn outward and of retreating through an area adjacent to the wiring bar, the interference inhibiting member spreading in a planar shape when drawn out.

### CROSS-REFERENCE TO RELATED APPLICATIONS

The present application claims priority under 35 U.S.C. §119 of Japanese Application No. 2016-155501, filed on Aug. 8, 2016, the disclosure of which is expressly incorporated by reference herein in its entirety.

### BACKGROUND OF THE INVENTION

### 1. Field of the Invention

The present invention relates to a technology supporting a wiring bar used when manufacturing a wire harness.

### 2. Description of Related Art

Japanese Patent Laid-open Publication No. 2000-195352 discloses a wire harness assembly layout board device that includes a wiring board on which various jigs can be arranged required to assemble a wire harness; a large number of wire harness assembly jigs arranged on the wiring board; and a display displaying, on the wiring board, an image required to assemble the wire harness such that the image is visible from a front surface side of the wiring board.

In order to assemble a wire harness using the wire harness assembly layout board device disclosed in Japanese Patent Laid-open Publication No. 2000-195352, various end portions of temporary couplings temporarily assembling a plurality of wires, end portions of a plurality of wires, and the like must be sequentially transferred to a large number of wire harness assembly jigs.

However, because a large number of wire harness assembly jigs are provided standing upright on the wiring board, when transferring the various end portions of the temporary couplings, the end portions of the wires, and the like to the wire harness assembly jigs in target locations, a middle portion of the wires may get caught on other wire harness assembly jigs.

### SUMMARY OF THE INVENTION

Given this, the present invention inhibits a wire from catching on a wire harness assembly jig when an end portion of a temporary coupling or an end portion of a wire is transferred from a wiring bar to a wire harness assembly jig on a wiring board.

In order to resolve the above-noted issue, a wiring bar support device according to an aspect of the present invention includes a wiring bar capable of holding an end portion of a temporary coupling or an end portion of a wire; a bar support supporting the wiring bar; and an interference inhibiting mechanism that includes an interference inhibiting member capable of being drawn outward and of retreating through an area adjacent to the wiring bar, the interference inhibiting member spreading in a planar shape when drawn out.

According to another aspect, the interference inhibiting member is a non-light-transmissive member.

According to another aspect, the interference inhibiting member is a light-transmissive member.

According to another aspect, the interference inhibiting mechanism is configured to include a sheet that can be rolled up as the interference inhibiting member; and a roll-up mechanism allowing the sheet to be rolled up and drawn out.

According to another aspect, the roll-up mechanism includes a biaser biasing the sheet in a roll-up direction.

A wire harness assembly device according to another aspect includes the wiring bar support device described above, the wiring bar support device further including a catch provided on a drawing-out side end portion of the interference inhibiting member; and a wire harness assembly layout board device. The wire harness assembly layout board device includes a wiring board; a plurality of wire harness assembly jigs provided standing upright on the wiring board; a strike provided standing upright on the wiring board and capable of catching the catch; and a wiring board support supporting the wiring board.

According to another aspect, a plurality of the strikes are provided standing upright on the wiring board at different positions in a draw-out direction of the interference inhibiting member.

According to another aspect, the wire harness assembly layout board device is capable of displacing along a wire harness assembly line, and the wiring bar support device is configured to receive a force displacing the wire harness assembly layout board device and is capable of displacing together with the wire harness assembly layout board device.

A method of manufacturing a wire harness according to another aspect utilizes the wiring bar support device described above and includes: (a) in a state where the interference inhibiting member is drawn out and covers a portion of the plurality of wire harness assembly jigs provided standing upright on the wiring board of the wire harness assembly layout board device, transferring the end portion of the temporary coupling or the end portion of the wire held by the wiring bar to a wire harness assembly jig, of the plurality of wire harness assembly jigs provided standing upright on the wiring board, that is not covered by the interference inhibiting member; and (b) in a state where the interference inhibiting member is retracted, transferring the end portion of the temporary coupling or the end portion of the wire held by the wiring bar to a wire harness assembly jig, of the plurality of wire harness assembly jigs provided standing upright on the wiring board, that was covered by the interference inhibiting member in (a).

According to the above aspects, in a state where the wiring bar support device is deployed close to the wire harness assembly layout board device, the interference inhibiting member can be drawn out and can cover a portion of the plurality of wire harness assembly jigs provided standing upright on the wiring board of the wire harness assembly layout board device. In this state, the end portion of the temporary coupling or end portion of the wire held by the wiring bar can be transferred to a wire harness assembly jig, of the plurality of wire harness assembly jigs provided standing upright on the wiring board, that is not covered by the interference inhibiting member. At this point, the wire is unlikely to be caught on any of the plurality of wire harness assembly jigs that are covered by the interference inhibiting member. Therefore, the wire can be inhibited from catching on the wire harness assembly jigs when the end portion of the temporary coupling or the end portion of the wire is transferred from the wiring bar to the wire harness assembly jigs on the wiring board.

According to another of the above-described aspects, in a state where a portion of the wire harness assembly jigs is covered by the non-light-transmissive interference inhibiting member, the end portion of the temporary coupling or end portion of the wire held by the wiring bar can be transferred to a wire harness assembly jig, of the plurality of wire harness assembly jigs provided standing upright on the wiring board, that is not covered by the interference inhibiting member. At this point, a worker cannot see the wire harness assembly jigs not subject to transfer, and therefore the worker can readily transfer the end portion of the temporary coupling or the end portion of the wire to the wire harness assembly jigs that are subject to transfer.

According to another aspect described above, the wire harness assembly jigs covered by the interference inhibiting member can be viewed through the interference inhibiting member. Therefore, any defects or the like in the wire harness assembly jigs can be identified.

According to another aspect described above, in a state where the sheet is rolled up, a configuration of the device can be made more compact.

According to another aspect described above, the sheet can be biased in the roll-up direction, and therefore when the drawing-out side end portion of the sheet is fixated, a drawn-out portion can be maintained in a drawn-out state.

According to another aspect described above, when the interference inhibiting member is drawn out and the catch on the drawing-out side end portion thereof is caught on the strike on the wiring board, a portion of the plurality of wire harness assembly jigs provided standing upright on the wiring board can be readily covered by the interference inhibiting member.

According to another aspect described above, when different strikes are provided to catch the catch, a draw-out amount of the interference inhibiting member can be readily adjusted.

According to another aspect described above, the wiring bar support device can be displaced together with the wire harness assembly layout board device.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a schematic front view of a wiring bar support device according to an embodiment;

FIG. 2 is a schematic front view of the wiring bar support device in a state where a sheet is drawn out;

FIG. 3 is a schematic side view of the wiring bar support device;

FIG. 4 is a schematic side view of the wiring bar support device in the state where the sheet is drawn out;

FIG. 5 is a schematic front view of a wire harness assembly device in the state where the sheet is drawn out;

FIG. 6 is a schematic side view of the wire harness assembly device in the state where the sheet is drawn out;

FIG. 7 is a schematic front view of the wire harness assembly device in a state where the sheet is stored;

FIG. 8 is a schematic side view of the wire harness assembly device in the state where the sheet is stored;

FIG. 9 is a schematic side view of a wire harness assembly device according to a first modification;

FIG. 10 is a schematic front view of a wire harness assembly device according to a second modification;

FIG. 11 is a schematic plan view of a wire harness assembly device according to a third modification; and

FIG. 12 is a schematic front view of the wire harness assembly device according to the third modification.

### DETAILED DESCRIPTION OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the forms of the present invention may be embodied in practice.

Hereafter, a wiring bar support device, wire harness assembly device, and method of manufacturing a wire harness are described according to an embodiment.

Wiring Bar Support Device

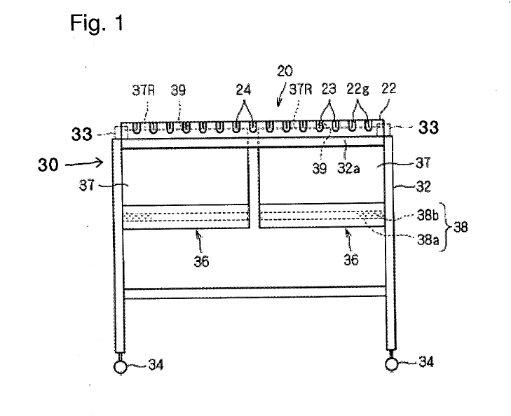

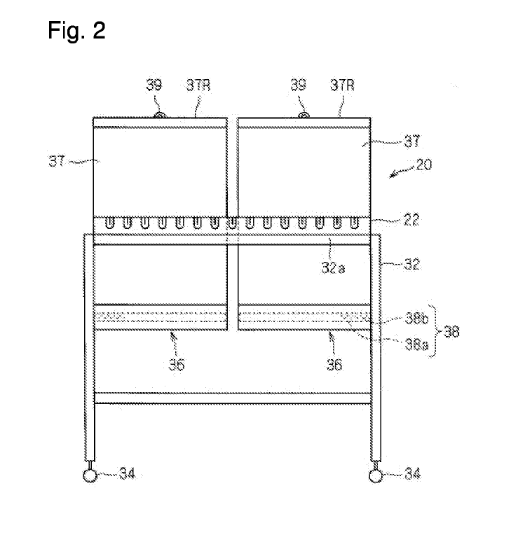

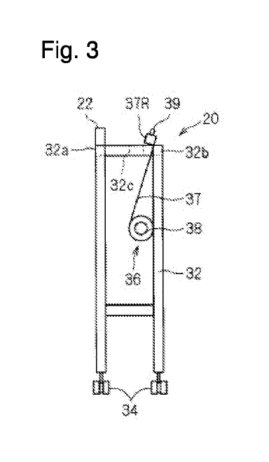

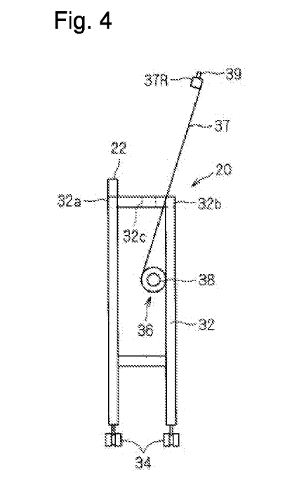

First, a wiring bar support device is described. A wiring bar support device 20 according to the present embodiment is a member which, when assembling a wire harness on a wire harness assembly layout board (described below), supports a temporary coupling (also referred to as a sub-assembly), a wire with terminal, or similar components configuring the wire harness. FIGS. 1 and 2 are schematic front views of the wiring bar support device 20, while FIGS. 3 and 4 are schematic side views of the wiring bar support device 20. FIGS. 1 and 3 illustrate a state in which a sheet 37 (interference inhibiting device) is stored, while FIGS. 2 and 4 illustrate a state where the sheet 37 is drawn out.

The wiring bar support device 20 includes a wiring bar 22, a bar support 30, and an interference inhibiting mechanism 36.

The wiring bar 22 is configured to be capable of holding an end portion of a temporary coupling or an end portion of a wire. More specifically, the wiring bar 22 is formed in a long shape. A plurality of slits 24 are provided to the wiring bar 22 in an extension direction of the wiring bar 22. For example, a configuration is possible in which a U-shaped depression 22g is formed in a side portion of the wiring bar 22, an elastic member 23 such as a rubber plate is held in the depression 22g, and the slit 24 is then formed in the elastic member 23, the slit 24 oriented toward a bottom of the depression 22g. In such a case, the elastic member 23 can be elastically deformed so as to open the slit 24 and the end portion of the temporary coupling or the end portion of the wire can be detachably held in the slit 24 by an elastic restoration force of the elastic member 23.

The bar support 30 is configured to be capable of supporting the wiring bar 22. More specifically, the bar support 30 includes a support frame 32, which is an assembly of rod-like members made of metal or resin.

An upper front frame 32a and an upper back frame 32b are provided to a top side of the support frame 32, and the wiring bar 22 is supported on the upper front frame 32a in the extension direction of the upper front frame 32a. The wiring bar 22 is preferably supported on the support frame 32 so as to be detachable. For example, a support 33 is provided at both end portions of the upper front frame 32a, and depressions into which both end portions of the wiring bar 22 can be arranged are formed on the support 33 (see FIG. 1). Then, by fitting the two end portions of the wiring bar 22 into the depressions of the support 33, the wiring bar 22 is detachably supported on the support frame 32. The wiring bar 22 may also be fixated to the support frame 32 by magnetism, screwing, or the like. Using the support frame 32, the wiring bar 22 is supported at a height appropriate to unloading work performed by a worker.

An upper middle frame 32c is provided to the top side of the support frame 32 and between the upper front frame 32a and the upper back frame 32b. A gap is formed between the upper back frame 32b and the upper middle frame 32c through which the sheet 37 can pass and through which a rod 37R attached to a leading edge portion of the sheet 37 cannot pass (see FIG. 3).

In addition, the bar support 30 includes a caster 34 displacing the wiring bar support device 20.

The interference inhibiting mechanism 36 includes the sheet 37 as the interference inhibiting device, and a roll-up mechanism 38. In this example, two interference inhibiting mechanisms 36 are provided to the bar support 30 in a width direction thereof. However, a single interference inhibiting mechanism 36, or three or more, may be provided instead.

The sheet 37 is configured by a cloth or resin sheet, for example, is capable of being drawn out and retracted, and is configured to be capable of spreading in a planar shape in a drawn-out state. The rod 37R is affixed to the leading edge portion of the sheet 37.

The roll-up mechanism 38 includes a rolling core 38a and a biaser 38b, and is configured to allow the sheet 37 to be rolled up and drawn out. The rolling core 38a has a tubular shape, is coupled to a base end portion of the sheet 37, and is configured to be capable of rolling up the sheet 37. A first end of the biaser 38b is coupled to the rolling core 38a while being prevented to relatively rotate, and a second end of the biaser 38b is configured by a coil spring or the like coupled to a portion of the roll-up mechanism 38 that is incapable of rotation (a portion fixated to the frame 32) or the like. In addition, when the sheet 37 is drawn out from a state where the rolling core 38a has rolled up the sheet 37, the biaser 38b is twisted and a biasing force rolling up the sheet 37 is generated. Accordingly, the biaser 38b biases the sheet 37 in a roll-up direction.

The roll-up mechanism 38 is supported at a middle position in a height direction of the support frame 32, in a posture that is horizontal with respect to the biaser 38b. When drawn out from the roll-up mechanism 38, the sheet 37 can be drawn out to an exterior and can retract through an area adjacent to the wiring bar 22. In this example, the sheet 37 can be drawn upward through a space between the upper back frame 32b and the upper middle frame 32c, and can be unfurled into a planar shape in the drawn-out state. In addition, when the sheet 37 is rolled up by the roll-up mechanism 38 and the rod 37R reaches a position abutting the upper back frame 32b and the upper middle frame 32c, any further roll-up of the sheet 37 is inhibited.

In addition to the sheet 37, which is pliable enough to be rolled up, a sheet-like member folded in a bellows shape, a plate-like member which is displaced by sliding so as to be drawn out and retracted while maintaining a flat surface, and the like can be used as the interference inhibiting device.

A catch 39 is provided to a leading edge portion of the sheet 37 in a draw-out direction. In this example, the catch 39 is configured such that two ends of a rod-like member bent in a half-circle shape are fixated to a middle portion of the rod 37R in the extension direction. A rod-like member provided projecting from a wiring board 42 (described below) can be inserted through the catch 39 and be caught. Accordingly, a state in which the sheet 37 is drawn out can be maintained. The catch 39 may be any configuration capable of catching on a rod-like portion, projecting portion, or the like. Additional examples may include a hook-shaped portion, a pliant string-like member provided in an annular shape, or the like. A configuration is also possible in which the drawn-out state of the sheet 37 is maintained by a clip pinching the leading edge of the sheet 37, as is a configuration in which the drawn-out state of the sheet 37 is maintained using the magnetism of a permanent magnet, an electromagnet, or the like.

Wire Harness Assembly Device and Method of Manufacturing Wire Harness

A wire harness assembly device and a method of manufacturing a wire harness using the wire harness assembly device are now described.

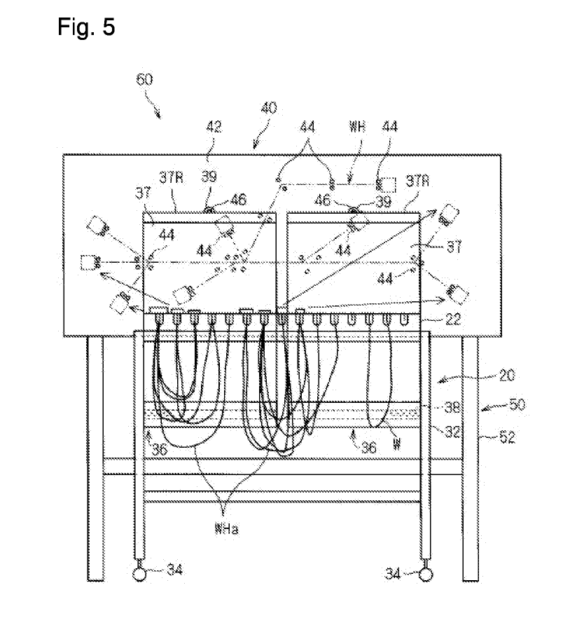

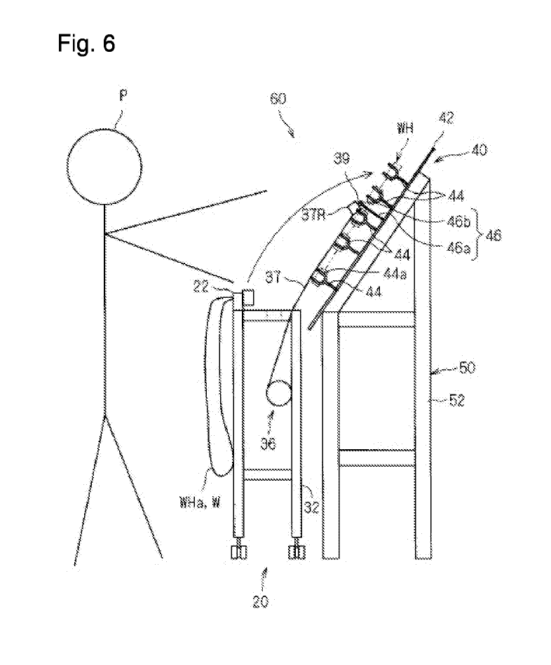

First, the wire harness assembly device is described. FIG. 5 is a schematic front view illustrating a wire harness assembly device 60. FIG. 6 is a schematic side view illustrating the wire harness assembly device 60. The wire harness assembly device 60 includes the wiring bar support device 20 and a wire harness assembly layout board device 40. The wiring bar support device 20 is as described above.

The wire harness assembly layout board device 40 includes the wiring board 42, a wire harness assembly jig 44, and a layout board support 50.

The wiring board 42 is formed in a plate shape. A route or the like of a wire harness WH to be assembled is preferably indicated on the wiring board 42.

The wire harness assembly jig 44 supports a portion of the wire harness WH to be assembled, and is configured to be capable of holding a temporary coupling WHa or wire W (wire with terminal) configuring the wire harness WH during manufacture of the wire harness WH. In a representative configuration of the wire harness assembly jig 44, a U-shaped portion 44a is formed on a top portion of a rod-like portion, the temporary coupling WHa or wire W is arranged within the U-shaped portion 44a, and the temporary coupling WHa or wire W is supported at a fixed position on the wiring board 42. The wire harness assembly jig 44 may also have a configuration in which an even greater number of additional rod-like members are provided standing upright, or the like. Moreover, the temporary coupling WHa is configured by a plurality of wires constituting a portion of those configuring the wire harness WH. The temporary coupling WHa is achieved, in one arrangement, by connecting at least one end portion of the plurality of wires to a connector. A plurality of such temporary couplings WHa and wires W are arranged on the wire harness assembly layout board device 40 and end portions of the wires are connected to the connectors, thereby being assembled in one arrangement of the wire harness WH.

A strike 46 is provided standing upright on the wiring board 42. The strike 46 is configured to be capable of catching the catch 39. In this example, the strike 46 is configured so as to provide a spherical portion 46b on a forefront end of a rod-like portion 46a which stands upright on the wiring board 42. Then, in a state where the catch 39 passes within the strike 46, the spherical portion 46b retains the catch 39. In addition, the strike may also be configured by a simple rod shape, a hook shape, or the like. Alternatively, the wire harness assembly jig may be used as the strike.

The layout board support 50 is configured to be capable of supporting the wiring board 42. More specifically, the layout board support 50 includes a support frame 52, which is an assembly of rod-like members made of metal or resin.

The wiring board 42 is supported on a top portion of the support frame 52. In this example, the support frame 52 supports the wiring board 42 in an oblique posture where the wire harness assembly jig 44 is oriented obliquely upward. A position of a lower edge of the wiring board 42 is preferably a position substantially the same as that of the wiring bar 22, which is supported by the wiring bar support device 20.

The wiring bar support device 20 is arranged forward of the wire harness assembly layout board device 40 and in a posture where the wiring bar 22 lies along and forward of the lower edge of the wiring board 42. In such an arrangement, the wire harness assembly device 60 is used during a task of transferring the temporary coupling WHa or the wire W supported on the wiring bar 22 to the wiring board 42.

An example of a task of assembling the wire harness WH using the wire harness assembly device 60 is now described.

First, as shown in FIGS. 5 and 6, the wiring bar 22 holding at least one of the temporary coupling WHa and the wire W is readied at the wiring board 42, and is placed on the wiring bar support device 20 for support. In a state where the wiring bar 22 is deployed forward of the lower edge of the wiring board 42, the rod 37R is pulled, the sheet 37 is drawn out so as to cover a region from below the wiring board 42 to a midway portion above the wiring board 42, and the catch 39 is engaged with the strike 46. This creates a state where a portion of the plurality of wire harness assembly jigs 44 provided standing upright on the wiring board 42, and in particular a portion of the wire harness assembly jigs 44 on a lower side of the wiring board 42, is covered by the sheet 37. In this example, the wire harness assembly jigs 44 in a middle portion on the lower side of the wiring board 42 are covered by the sheet 37 and, accordingly, the wire harness assembly jigs 44 are exposed on two sides and above the sheet 37. A middle portion of the sheet 37 is in a suspended state, such that the middle portion of the sheet 37 hangs over the wire harness assembly jigs 44 located between the lower edge of the wiring board 42 and the strike 46. In this state, a worker P separates the end portion of the temporary coupling WHa or the end portion of the wire W, which is held by the wiring bar 22, from the wiring bar 22 and, passing above the sheet 37, transfers the end portion to a wire harness assembly jig 44 not covered by the sheet 37 (step (a)). In this example, the wire harness assembly jigs 44 are exposed above and to both sides of the sheet 37, and the end portion of the temporary coupling WHa or the end portion of the wire W is held by these. When the end portion of the temporary coupling WHa or the end portion of the wire W is displaced toward and held by the wire harness assembly jigs 44, the wire W which is continuous with the end portion is pulled. At this point, the portion of the wire harness assembly jigs 44 located in the middle portion or the like on the lower side of the wiring board 42 is covered by the sheet 37. Therefore, the wire W is unlikely to be caught on these wire harness assembly jigs 44.

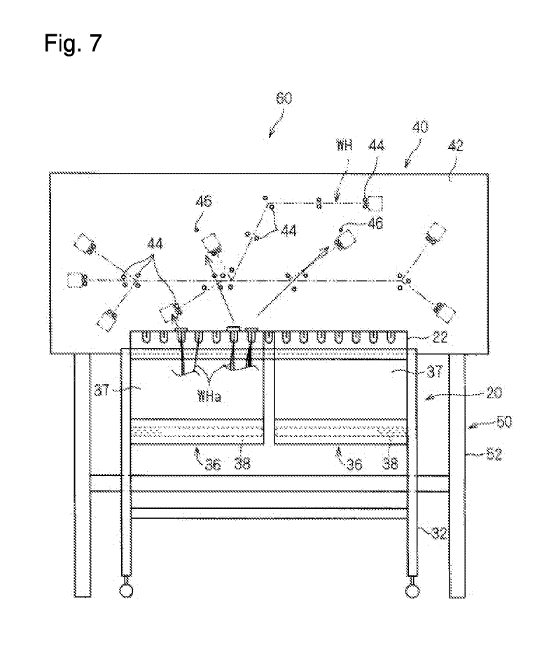

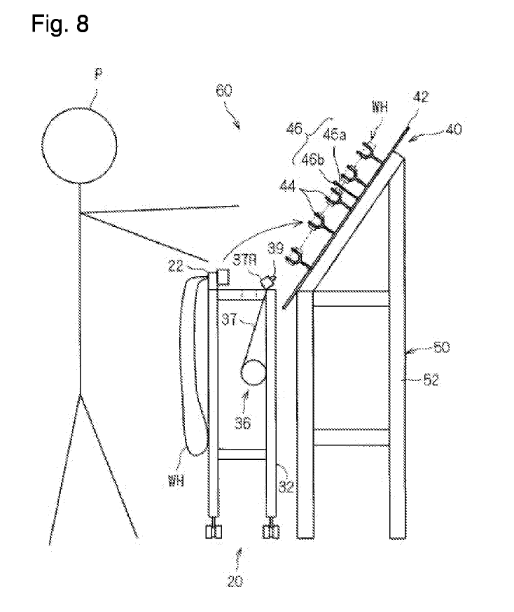

After the end portion of the temporary coupling WHa or the end portion of the wire W has been transferred to the wire harness assembly jig 44 not covered by the sheet 37, as shown in FIGS. 7 and 8, the catch 39 is separated from the strike 46 and the sheet 37 is rolled up by the biasing force of the roll-up mechanism 38. This creates a state where the sheet 37 retreats from the wiring board 42, and a state where all of the wire harness assembly jigs 44 on the wiring board 42 are exposed. In this state, the remaining end portion of the temporary coupling WHa or end portion of the wire W held by the wiring bar 22 is transferred to a wire harness assembly jig 44 provided standing upright on the wiring board 42 and that was covered by the sheet 37 in step (a) above (step (b)). At this point, the wire harness assembly jigs 44 to which the end portion is transferred are deployed comparatively near the wiring bar 22, and therefore when the end portion of the temporary coupling WHa or the end portion of the wire W are transferred to these, the wire W is unlikely to catch on the other wire harness assembly jigs 44.

After this, the temporary coupling WHa or the wire W wired on the wiring board 42 is bundled, or a component such as a corrugated tube or a vehicle fixation clamp member is mounted thereto, if necessary, to produce the wire harness WH.

According to the wiring bar support device 20, the wire harness assembly device 60, and the method of manufacturing the wire harness WH configured in this way, in a state where the wiring bar support device 20 is deployed close to the wire harness assembly layout board device 40, the sheet 37 can be drawn out and can cover a portion of the plurality of wire harness assembly jigs 44 provided standing upright on the wiring board 42. In this state, the end portion of the temporary coupling WHa or the end portion of the wire W held by the wiring bar 22 can be transferred to the wire harness assembly jigs 44 not covered by the sheet 37 while being inhibited from catching on the wire harness assembly jigs 44 covered by the sheet 37. Also, when the sheet 37 is rolled up, the end portion of the temporary coupling WHa or the end portion of the wire W can be transferred from the wiring bar 22 to the wire harness assembly jigs 44 which are comparatively nearby, and therefore the wire W is unlikely to catch on the other wire harness assembly jigs 44 at this point, either. Therefore, the wire W can be inhibited from catching on the wire harness assembly jigs 44 when the end portion of the temporary coupling WHa or the end portion of the wire W is transferred from the wiring bar 22 to the wire harness assembly jigs 44 on the wiring board 42. Also, because the wire W is unlikely to be caught on the wire harness assembly jigs 44, damage to the wire W can also be inhibited.

In addition, the present embodiment is configured to cover the wire harness assembly jigs 44 with the sheet 37. Therefore, in a retracted state, the sheet 37 can be rolled up for storage and the configuration of the device can be made more compact. Also, when the sheet 37 is drawn out and the leading edge portion is supported, this can create a state where the middle portion of the sheet 37 is taut, and therefore a configuration supporting the sheet 37 in the drawn-out state can also be simplified.

Also, the present embodiment is configured to be capable of drawing the sheet 37 out from and rolling the sheet 37 up on the roll-up mechanism 38, and of exerting a bias in the roll-up direction with the biaser 38b. Therefore, the sheet 37 can be readily rolled up and stored. In addition, the drawn-out portion can maintain the drawn-out state, and therefore the sheet 37 is readily unfurled into a taut state.

Also, the catch 39 is provided to the leading edge portion of the sheet 37 in the draw-out direction, and therefore when the catch 39 is caught on the strike 46, the sheet 37 can be readily held in the drawn-out state with a simple configuration. Moreover, when the strike 46 is configured to be capable of advancing and retreating, or of falling back and rising, from the wiring board 42, the strike 46 is unlikely to become a hindrance during other tasks.

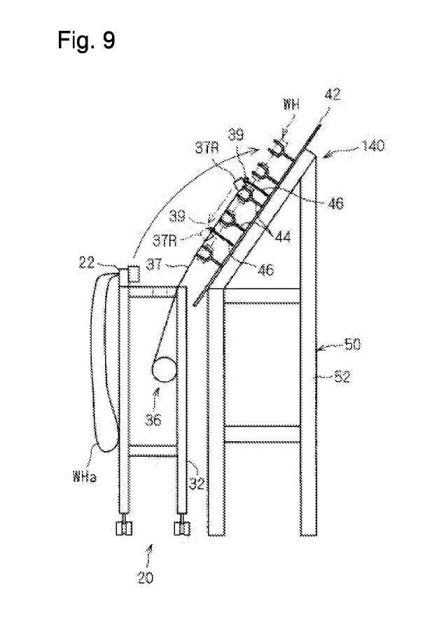

In the present embodiment, a single strike 46 is provided for each sheet 37. However, as in a wire harness assembly layout board device 140 according to a first modification and shown in FIG. 9, a plurality of strikes 46 may also be provided standing upright at different positions on the wiring board 42 in the draw-out direction of the sheet 37 (different positions in a vertical direction).

Accordingly, states can be created in which the sheet 37 is drawn out over the wiring board 42 by different draw-out amounts. Accordingly, when the end portion of the temporary coupling WHa or the end portion of the wire W is being transferred to the wire harness assembly jigs 44 located further away from the wiring bar 22, for example, the sheet 37 can be pulled to an upper position. Therefore, a state can be created in which an even greater number of wire harness assembly jigs 44 are covered, and the wire W can be more reliably inhibited from catching. Also, when the end portion of the temporary coupling WHa or the end portion of the wire W is being transferred to the wire harness assembly jigs 44 located a moderate distance from the wiring bar 22, the sheet 37 can be pulled to a lower position. A state can be created in which those wire harness assembly jigs 44 are covered, and the wire W can be more reliably inhibited from catching. Also, when the end portion of the temporary coupling WHa or the end portion of the wire W is being transferred to the wire harness assembly jigs 44 close to the wiring bar 22, the sheet 37 can be placed in a stored state, and the transfer work can be performed as described above.

The strike 46 may of course also be provided to a greater number of locations (three or more) in the draw-out direction of the sheet 37.

Also, when a non-light-transmissive member is used as the sheet 37, for example, the wire harness assembly jigs 44 not subject to transfer can be hidden in step (a) above. At this point, the worker P cannot see the wire harness assembly jigs 44 not subject to transfer, and therefore the worker P can readily transfer the end portion of the temporary coupling WHa and the end portion of the wire W to a somewhat narrowed number of wire harness assembly jigs 44 that are subject to transfer.

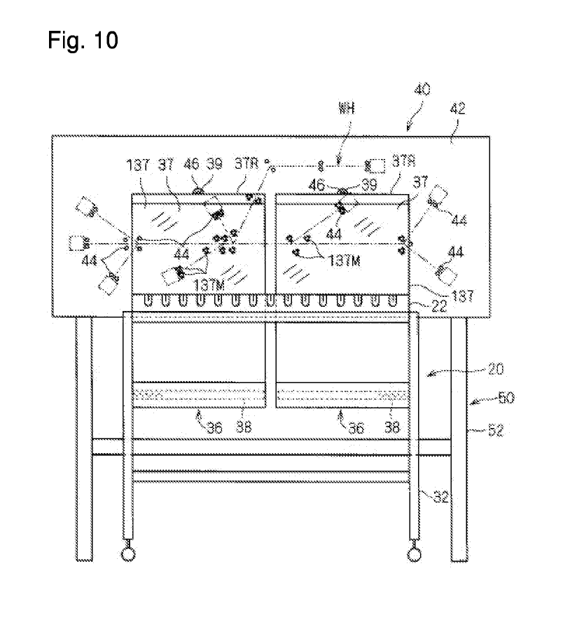

Also, as shown in a second modification shown in FIG. 10, a light-transmissive member may also be used as a sheet 137, which corresponds to the sheet 37. By doing so, the wire harness assembly jigs 44 covered by the sheet 137 can be viewed through the sheet 137. Accordingly, any defects or the like in the wire harness assembly jigs 44 can be identified. For example, a mark 137M indicating a correct design position of the wire harness assembly jigs 44 may be applied to the sheet 137. By doing so, in a state where the wiring board 42 is partially or entirely covered by the sheet 137, the position of the mark 137M and the positions of the wire harness assembly jigs 44 observed through the sheet 137 can be compared, enabling confirmation of whether the wire harness assembly jigs 44 are in the correct positions with no offset.

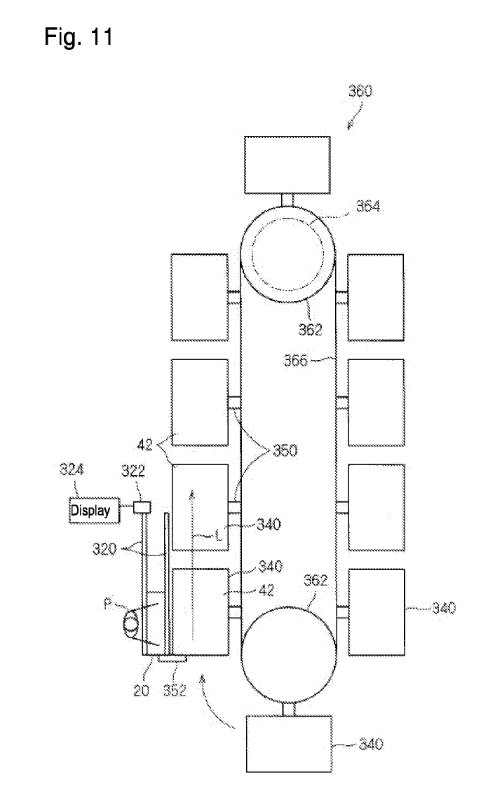

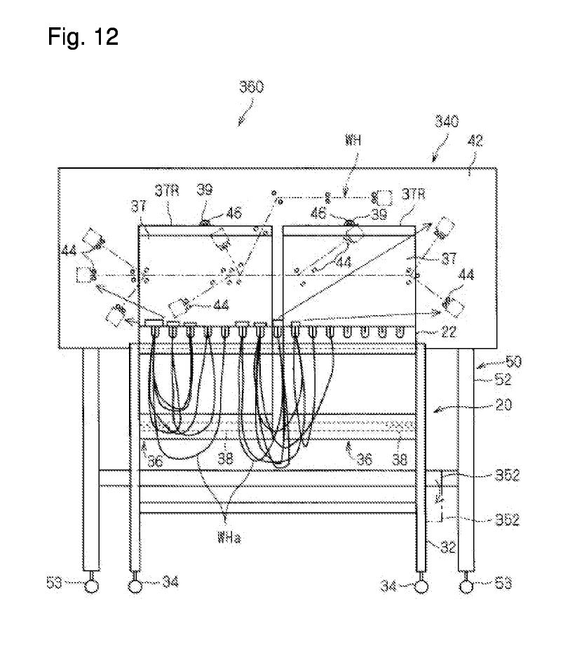

FIGS. 11 and 12 illustrate a wire harness assembly device 360 according to a third modification, in which the wiring bar support device 20 is applied to a wire harness assembly layout board device 340 which is cyclically rotated.

In the wire harness assembly device 360, a pair of rotating bodies 362 (pulleys, gears) are provided with a space therebetween. At least one of the pair of rotating bodies 362 is rotationally driven by a rotation driver 364 such as a motor. An annular belt 366 (or annular chain) is wrapped around the pair of rotating bodies 362, and the annular belt 366 is driven by the rotation driver 364 to cyclically rotate along a track-shaped path.

The wire harness assembly layout board device 340 is configured to include a caster 53 on a bottom side of the layout board support 50 of the wire harness assembly layout board device 340. A plurality of wire harness assembly layout board devices 340 are deployed on an exterior side of the annular belt 366 oriented such that the wiring board 42 faces outward, and a back surface portion of each of the wire harness assembly layout board devices 340 is coupled at intervals to the annular belt 366 via a coupling member 350. In addition, in association with the cyclical rotation of the annular belt 366, the plurality of wire harness assembly layout board devices 340 are driven to displace along a track-shaped wire harness assembly line L on the exterior side of the annular belt 366. The worker P performs the work of sequentially assembling the wire harnesses WH on each wire harness assembly layout board device 340 that is conveyed to a position on the exterior side of a displacement route of the wire harness assembly layout board devices 340.

The wiring bar support device 20 is provided at a midway point on the displacement route of the wire harness assembly layout board devices 340. The wiring bar support device 20 is configured to receive a force displacing the wire harness assembly layout board devices 340 and to be capable of displacing together with the wire harness assembly layout board devices 340.

In this example, a pair of rails 320 are provided along a midway point on a first straightaway-like displacement route of the wire harness assembly layout board devices 340. The wiring bar support device 20 is configured to be capable of displacement on an interior side of the pair of rails 320 and along an extension direction of the pair of rails 320. Moreover, the pair of rails 320 are provided to a portion running from a first end to a middle portion of the first straightaway-like displacement route. A detector 322 such as an optical sensor is provided to a portion on a terminal end side of the pair of rails 320, and the detector 322 is configured to be capable of detecting the wiring bar support device 20 when the wiring bar support device 20 reaches the terminal end of the pair of rails 320. In addition, the detector 322 is connected to a display 324 such as a lamp or liquid crystal display device, and when the wiring bar support device 20 is detected by the detector 322, this is displayed on the display 324.

A pushing portion 352 is provided to a portion closer to one side of the layout board support 50 of the wire harness assembly layout board device 340. The pushing portion 352 is provided to a forward side of the layout board support 50 so as to be capable of standing upright and falling back. In an upright state, the pushing portion 352 projects forward of the layout board support 50. In this projecting state, the pushing portion 352 is configured to be capable of making contact with one side portion of the wiring bar support device 20, which displaces inside the pair of rails 320. Also, when the pushing portion 352 is in a fall-back state, the pushing portion 352 releases the contact with the wiring bar support device 20. The pushing portion may also be provided so as to be capable of projecting and retracting.

In addition, when the wire harness assembly layout board device 340 is driven by the rotation driver 364 and reaches a starting end side of the first straightaway route, the pushing portion 352, which is in the upright state, pushes and displaces the wiring bar support device 20 positioned at the starting end side of the pair of rails 320. The wiring bar support device 20 is pushed by the displacement of the wire harness assembly layout board device 340 and displaces together with the wire harness assembly layout board device 340. At this point, while adjusting the draw-out amount of the sheet 37, the worker P displaces together with the wire harness assembly layout board device 340 and the wiring bar support device 20, and begins transferring the end portion of the temporary coupling WHa or the end portion of the wire W supported on the wiring bar 22 to the wire harness assembly jigs 44 on the wiring board 42. When the transfer work ends, the pushing portion 352 is placed in the fall-back posture. Accordingly, the wiring bar support device 20 stops at that position and the wire harness assembly layout board device 340 continues displacing toward a subsequent downstream step. When exchange work is delayed and the wiring bar support device 20 reaches the terminal end of the pair of rails 320, this is displayed on the display 324. In such a case, another worker may assist, the device may be stopped, or the like.

When the exchange work ends, the worker P returns the wiring bar support device 20 to the starting end along the pair of rails 320, loads a new wiring bar 22 on which the temporary coupling WHa or wire W is arranged and, as described above, exchanges the end portion of the temporary coupling WHa and the end portion of the wire W onto the next wire harness assembly layout board device 340.

Accordingly, the displacing wire harness assembly layout board devices 340 can make use of the wiring bar support device 20 even in a work step of manufacturing a wire harness with an assembly line system, for example.

Modifications

The configurations described in the above embodiment and modifications can be combined as appropriate so long as they do not contradict each other.

In the above, the present invention is described in detail. However, the above description is, in all aspects, for exemplary purposes and the present invention is not limited by the description. Numerous modifications not given as examples are understood to be conceivable without departing from the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A wiring bar support device comprising:
a wiring bar configured to hold one of an end portion of a temporary coupling and an end portion of a wire;
a bar support supporting the wiring bar; and
an interference inhibiting mechanism that includes an interference inhibitor configured to be drawn outward and retracted inward through an area adjacent to the wiring bar, the interference inhibitor spreading in a planar shape when drawn out.

2. The wiring bar support device according to claim 1, wherein the interference inhibitor is a non-light-transmissive member.

3. The wiring bar support device according to claim 1, wherein the interference inhibitor is a light-transmissive member.

4. The wiring bar support device according to claim 1, wherein the interference inhibiting mechanism comprises:
a sheet that can be rolled up as the interference inhibitor; and
a roll-up mechanism configured to allow the sheet to be rolled up and drawn out.

5. The wiring bar support device according to claim 4, wherein the roll-up mechanism includes a biaser biasing the sheet in a roll-up direction.

6. A wire harness assembly device comprising:
the wiring bar support device according to claim 1, the wiring bar support device further including a catch provided on a drawing-out side end portion of the interference inhibitor; and
a wire harness assembly layout board device including a wiring board, a plurality of wire harness assembly jigs standing upright on the wiring board, a strike standing upright on the wiring board and configured to catch the catch, and a wiring board support supporting the wiring board.

7. The wire harness assembly device according to claim 6, wherein a plurality of the strikes are provided standing upright on the wiring board at different positions in a draw-out direction of the interference inhibitor.

8. The wire harness assembly device according to claim 6, wherein the wire harness assembly layout board device is configured to displace along a wire harness assembly line, and
the wiring bar support device receives a force displacing the wire harness assembly layout board device and is configured to displace together with the wire harness assembly layout board device.

9. A method of manufacturing a wire harness utilizing the wire harness assembly device according to claim 6, the method comprising:
(a) in a condition in which the interference inhibitor is drawn out and covers a portion of the plurality of wire harness assembly jigs standing upright on the wiring board of the wire harness assembly layout board device, transferring one of the end portion of the temporary coupling and the end portion of the wire held by the wiring bar to a wire harness assembly jig, of the plurality of wire harness assembly jigs standing upright on the wiring board, that is not covered by the interference inhibitor; and
(b) in a condition in which the interference inhibitor is retracted, transferring the one of the end portion of the temporary coupling and the end portion of the wire held by the wiring bar to a wire harness assembly jig, of the plurality of wire harness assembly jigs standing upright on the wiring board, that was previously covered by the interference inhibitor.
